(19) United States
(12) Patent Application Publication
(10) Pub. No.: US 2004/0083981 A1
(43) Pub. Date: May 6, 2004

(54) Disposable animal litter box liner

(76) Inventors: Angelina R. Nye, Maricopa, AZ (US); Jason L. Nye, Maricopa, AZ (US)

Correspondence Address: Angelina And Jason Nye, 51400 W Mockingbird LN, Maricopa, AZ, 85239, US

(21) Appl. No.: 10/694,512

(22) Filed: Oct. 27, 2003

Related U.S. Application Data
(60) Provisional application No. 60/421,979, filed on Oct. 28, 2002.

(51) Int. Cl. A01K 29/00

(52) U.S. Cl. 119/166

(57) ABSTRACT

A disposable litter box liner formed of a smooth rigid plastic material molded as one piece, a generally box shaped configuration upon insertion into an animal litter box for holding litter therein. The smooth rigid plastic material is claw resistant, fluid impermeable, snag and tear resistant to the animals and devices used to extract the animal urine and feces. The liner includes handles within the elongated opposite side panels which can be utilized by pushing in the perforated lines inward or outward when disposing of the litter box liner and used litter therein.

### CROSS-REFERENCE TO RELATED APPLICATIONS

This application claims the benefit of PPA Ser. No. 60/421,979

### SEQUENCE LISTING

None.

### BACKGROUND OF THE INVENTION

This invention relates to litter boxes, specifically to disposable litter box liners, having means that allow users to dispose of the used litter more conveniently and without any risk of tears which causes leakage of contaminated litter. Disposing of contaminated litter is displeasing and time consuming task. The litter box pan over time can become a bacteria trap, with encrusted buildup. Therefore, the required task of regular cleaning of the litter box pan itself becomes cumbersome.

U.S. Pat. No. 3,684,155 to Smith utilizes a plastic liner bag for the litter box pan. A disadvantage of a disposable plastic bag liner is that it tends to be ripped and torn by animals with claws as well as from the device used to scoop the contaminates from the litter. This invention is not limited to a specific litter box pan.

U.S. Pat. No. 5,167,205 to Bell and Kheradpir utilizes a self contained, stand alone product that incorporates a clay manufactured from two corrugated boards or similarly stiff material. It does not provide a liner that can be used with an existing litter box pan, does not provide a liner that can be used with other available litter pans or litter, and is intended for disposal of entire litter pan assemble.

U.S. Pat. No. 5,983,832 to Seo utilizes a self contained stand alone product that includes a cat litter box pan with a bag system, as well as a protective insert that will protect the walls of the bag system. A disadvantage of this design is that it does not provide a liner that can be used with existing litter box pan, does not provide a liner that can be used with other commercially available litter pans and litter. A disadvantage of a litter disposal bag rested into the pan is that the unprotected bottom of the liner would be ripped or torn by animal claws or the devices used to scoop the contaminates from the litter.

U.S. Pat. No. 5,488,929 Pierson a disposable cat litter box liner formed of flexible sheet material, preferable paper, is adapted assume a generally flat configuration prior to use, a generally box-shaped configuration upon insertion into a cat litter box for holding litter therein, and a generally bag-shaped configuration upon removal from the litter box for disposing of the litter therein. The liner includes an arrangement of fold lines associated with the end panels for permitting the liner to be folded into a generally flat configuration prior to use. The liner includes a pair of elongate opposite top panels, which can advantageously include handles facilitate lifting of the liner. When the top panels are clasped together and the liner lifted thereby with cat litter in the receptacle, the bottom panel collapses downward, the side panels collapse inward, and the liner assumes a generally bag-shaped configuration for disposal of the cat litter therein. A disadvantage of this design is that it tends to be ripped, torn or possibly consumed by animals that have teeth and claws. The paper material, upon contact with fluids will breakdown and the contaminated litter will break through the disposable bag shaped configuration.

### SUMMARY

The invention, an improved disposable litter box liner, is made of a smooth rigid plastic material molded as one piece which may be made from recycled plastic material. The invention is placed into the existing litter box pan, then litter is added into the disposable litter box liner. Once the used litter is ready to be disposed of the user would pick-up the litter box liner from the sides or by pushing in the perforated handles if desired, then discarded into trash receptacle or bag.

Several advantages of the invention is that the invention eliminates leakage of contaminates through tears caused by animal/s and by the device used to scoop the contaminates from the litter. The invention allows for easy and convenient disposal of the litter and disposable litter box liner by utilizing the handles. The number of times required to sanitize the litter box pan will be reduced due to leakage being eliminated by the said invention.

### DRAWINGS

FIG. 1 is a perspective view of a litter box liner of the present invention;

FIG. 2 is a lateral side sectional view of a litter box liner of the present invention;

FIG. 3 is a side sectional view of a litter box liner of the present invention;

FIG. 4 is a side sectional view of a portion of the litter box pan with the litter box liner being installed;

FIG. 5 is a side sectional view of a portion of the litter box pan with the litter box liner installed;

FIG. 6 is a side sectional view of a portion of the litter box pan with the litter box liner installed, showing the device removing the contaminates;

FIG. 7 is a side sectional view of a portion of the litter box pan with the litter box liner being disposed of;

### DETAILED DESCRIPTION

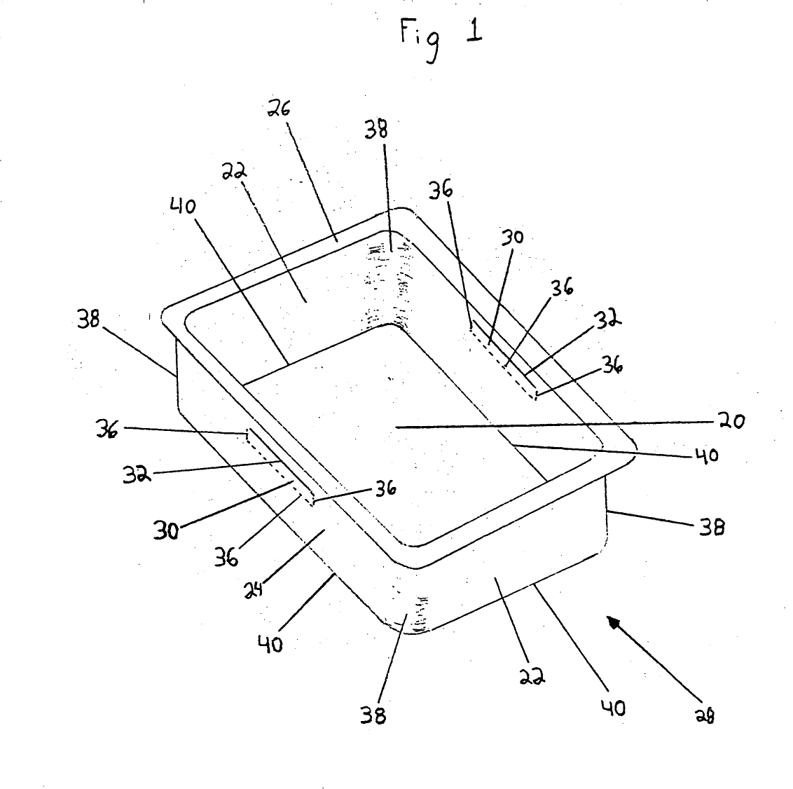

FIG. 1 Is a perspective view of litter box liner 28 constructed in accordance with the invention. The litter box liner 28 has a bottom panel 20 having opposite end portions rectangular in shape 24 and opposite side edge portions generally rectangular in shape 22. The bottom panel 20 is generally rectangular in shape.

A pair of opposite end panels 24 that are generally rectangular in shape are connected to the bottom panel edges 40 that are rounded 38, each of the opposite side edge panels generally rectangular in shape terminating at a top lip edge portion 26. Note that, and the preferred embodiment, the opposite end panels 24 terminate at the top lip edge portion 26. A pair of opposite end panels 22 that are generally rectangular in shape are connected to the bottom panel edges 40 that are rounded 38, each of the opposite side edge panels generally rectangular in shape terminating at a top lip edge portion 26. Note that, and the preferred embodiment, the opposite end panels 22 terminate at the top lip edge portion 26. The side panels and the end panels are connected to another by a end corners that are rounded 38 in a continuous uninterrupted side wall connected to the bottom panel 20, the wall forming with the bottom panel a receptacle for holding litter therein when the litter box liner is inserted. A flap 30 formed in both of the opposite end portions 24 with perforated lines that begins at each end of the fold lines 32, to form a rectangular shape to the other end of the fold lines 32 to form a handle by which a user may utilize. Numerous other handle means may be employed, such as a cord or rope member made of other suitable material to one or both of the top panels, ect.

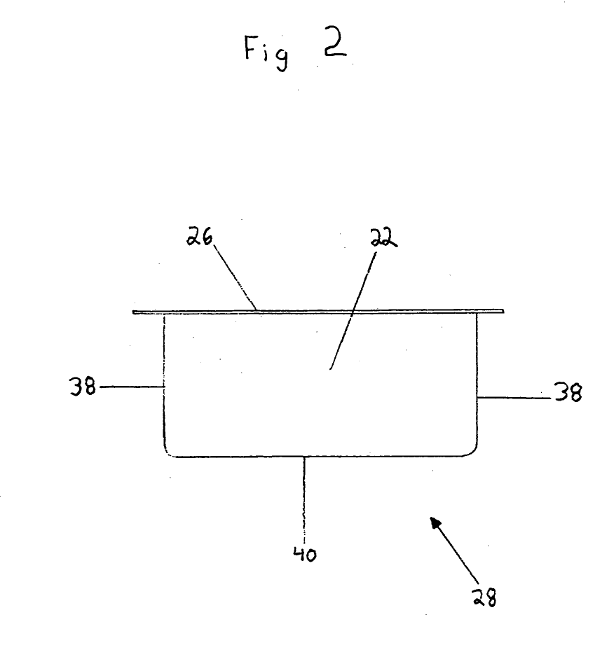

FIG. 2 Is a lateral side sectional view of litter box liner 28 constructed in accordance with the invention. The litter box liner 28 has opposite side edge portions generally rectangular in shape 22 and opposite end corners that are rounded 38, that continuously connect to bottom panel edges that are rounded 40.

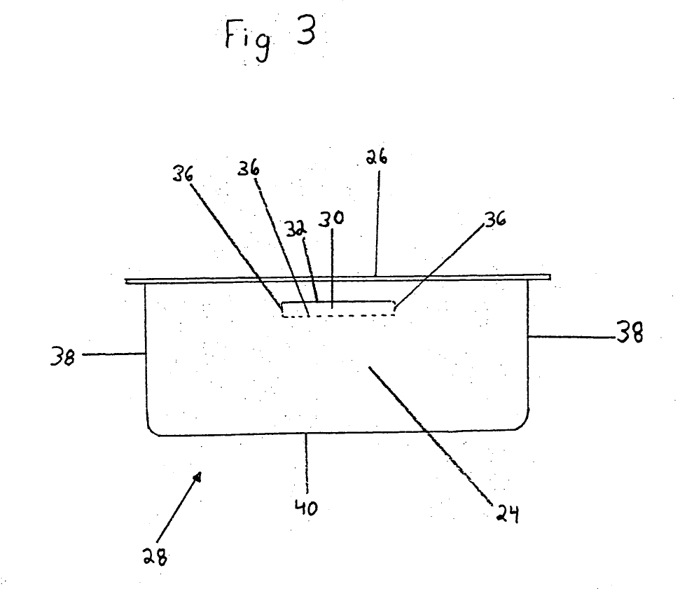

FIG. 3 Is a side sectional view of a litter box liner 28 of the present invention in accordance with the invention. The litter box liner 28 has opposite end portions generally rectangular in shape 24 and opposite end corners that are rounded 38, that continuously connect to bottom panel edges that are rounded 40. A flap 30 formed in both of the opposite end portions 24 with perforated lines that begins at each end of the fold lines 32, to form a rectangular shape to the other end of the fold lines 32 to form a handle by which a user may utilize.

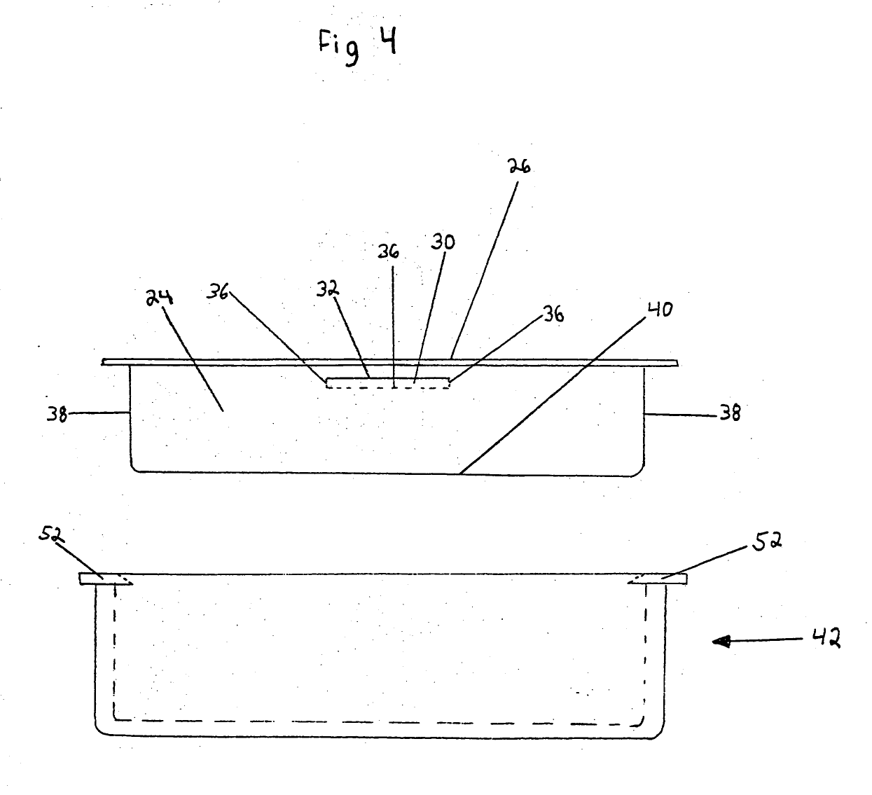

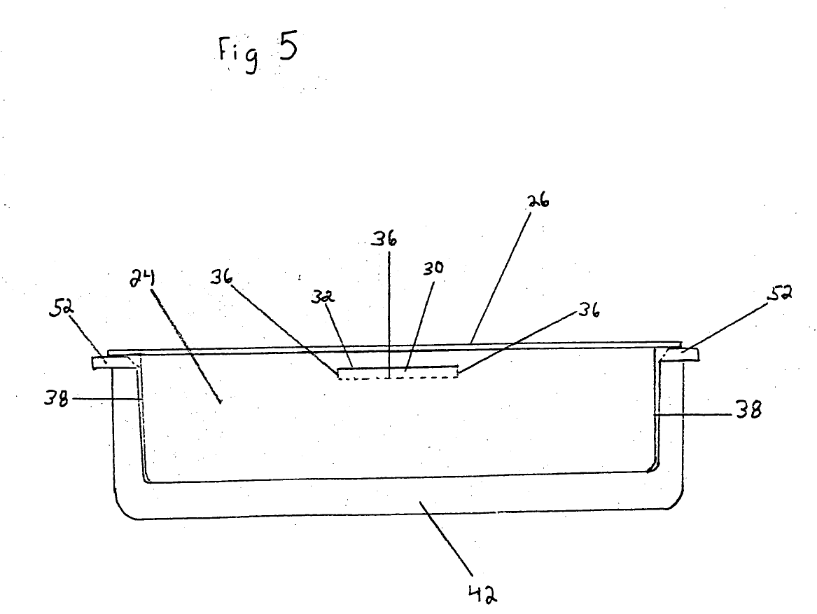

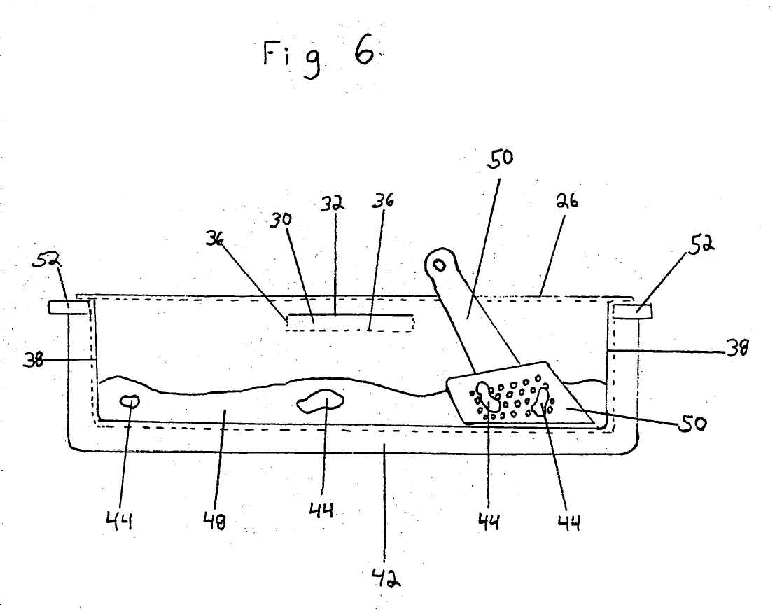

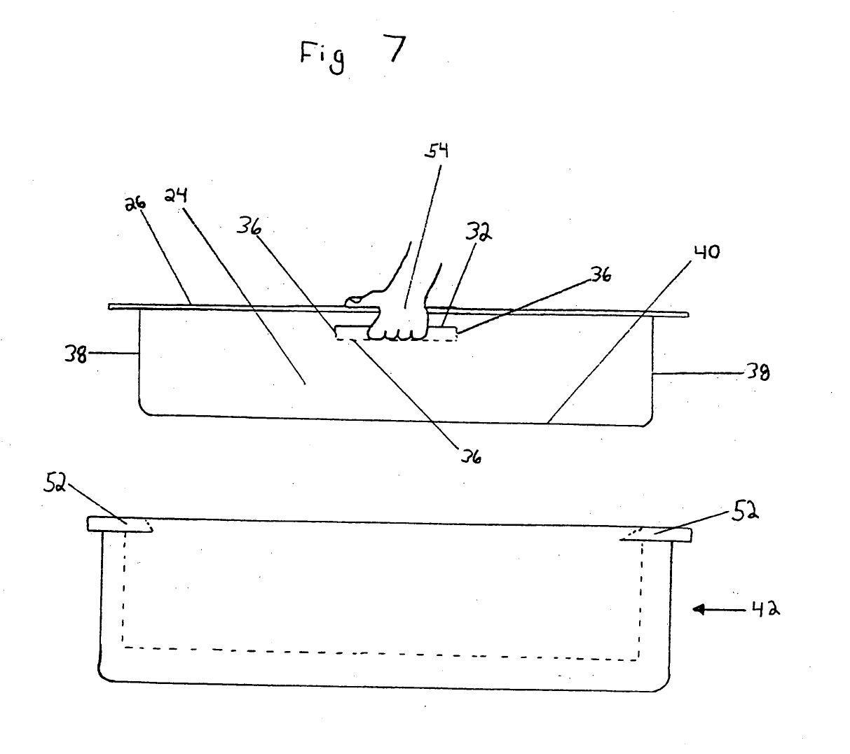

The use of the litter box liner invention is best illustrated in FIGS. 4-7. As shown in FIG. 4, the litter box liner 28 is being inserted into the litter box pan 42. As shown in FIG. 5 the litter box liner has been filled with litter 48. As shown in FIG. 6, the animal feces 44 and the animal urine 46 in the litter 48 are being removed by the device 50 used to extract such. As shown in FIG. 7, the litter box liner 28 is being disposed of and taken out of the litter box pan 42 by utilizing the perforated lines 36 that outline the flaps 30, which form when pushed open by hand of user 54.

### Reference Numerals

10 Bottom panel of litter box liner

22 A pair of opposite side edge portions rectangular in shape

24 A pair of opposite end portions rectangular in shape

26 Surrounding top lip of litter box liner

28 Litter box liner

30 A pair of flaps connected to one of the end panels

32 Opposite end fold lines on top of opposite end panels

36 A pair of perforated lines

38 Opposite end corners that are rounded

40 Opposite ends of bottom panel edges that are rounded

42 Litter box pan

44 Animal feces

46 Animal urine

48 Litter

50 Device used to extract contaminates

52 Litter box pan lip

54 Hand of user

### Operation of the Invention

To use litter box liner 28 with a litter box pan 42, the following steps should be taken:

(1) Insert the litter box liner 28 into the litter box pan 42.

(2) Pour a quantity of litter 48 into the litter box liner 28.

(3) After the animal has deposited the animal feces 44 and animal urine 46 then use the device used to extract the contaminates 50.

(4) When it is time to dispose of the litter 48 within the litter box liner 28, with each hand of user 54 push in the pair of flaps 30 that are on each end portion 22, which have perforated lines 36.

(5) Lift up the litter box liner 28 with the used litter 48 in it and discard into a bag or trash receptacle.

(6) Start again with a new litter box liner 28 and a new quantity of litter 48, repeat steps 1-5 as needed

1. A litter box liner made of smooth rigid plastic material molded as one piece in various sizes to accommodate various sizes of a litter box having sides extending upwardly from a bottom to a vertical height, said litter box liner comprising:
a bottom panel having opposite side edge portions and opposite end portions;
a pair of opposite end panels that are generally rectangular in shape are connected to the bottom panel edges that are rounded;
a pair of elongate opposite side panels generally rectangular in shape are connected to said bottom panel side edge portions that are rounded;
with said side panels and said end panels connected to one another to form a continuous uninterrupted side wall connected to said bottom panel, said wall forming with said bottom panel a receptacle for holding litter therein while inserted in animal litter box.

2. A litter box liner according to claim 1, further comprising handles which are outlined with perforated lines formed within the elongated opposite end panels for carrying said litter box liner and litter therein.

3. A litter box liner according to claim 1, having perforated handles that will not be compromised until the user utilizes the handles by pushing in the handles, whereby the perforated lines gives and breaks to form a handle.

4. A litter box liner according to claim 1, comprising of smooth rigid plastic material molded as one piece that is claw resistant, fluid impermeable, snag and tear resistant to the animals and the devices used to extract the animal urine and feces.

5. A litter box liner according to claim 1, wherein said litter box liner has a lip which extends around a perimeter of the said litter box liner and is connected to said side panels and said end panels.
